(19) United States
(12) Patent Application Publication
(10) Pub. No.: US 2024/0075762 A1
(43) Pub. Date: Mar. 7, 2024

(54) Mitigating distortions in printed images

(71) Applicant: LANDA CORPORATION LTD., Rehovot (IL)

(72) Inventors: Igal Ben-Dayan, Moshav Kochav Michael (IL); Almog Koren, Beer Sheva (IL); Ittai Wiener, Mevaseret Zion (IL); Yevgeny Zakharin, Petah Tikva (IL)

(21) Appl. No.: 18/261,852

(22) PCT Filed: Jan. 16, 2022
(86) PCT No.: PCT/IB2022/050328

§ 371 Date: Jul. 18, 2023

Related U.S. Application Data
(60) Provisional application No. 63/144,488, filed on Feb. 2, 2021.

(51) Int. Cl. B41J 29/38; B41J 2/005; B41J 2/21; G06F 3/12

(52) U.S. Cl. CPC B41J 29/38; B41J 2/0057; B41J 2/21; G06F 3/1208; G06F 3/1229

(57) ABSTRACT

A method including receiving a first signal indicative of a first electrical current measured on a first motion assembly (77) for moving a flexible substrate (44) that receives droplets of a printing fluid from an image forming station (60) to form an image thereon. A second signal indicative of a second electrical current measured on a second motion assembly (99) for moving the flexible substrate (44), is received, wherein a section of the flexible substrate (44) is moving between the first motion assembly (77) and the second motion assembly (99). A parameter, which is indicative of a distortion in the image, is calculated based on the first signal and the second signal. In response to detecting, based on the parameter, an increase in the distortion, a corrective action is applied to reduce the distortion.

### FIELD OF THE INVENTION

The present invention relates generally to digital printing systems, and particularly to methods and systems for mitigating distortions in digitally printed images.

### BACKGROUND OF THE INVENTION

Flexible substrates are sometimes used in reading media from and/or in applying media to the flexible substrate, such as in digital printing. Various techniques have been published for controlling tension applied to the flexible substrate during the reading and/or applying of the media.

For example, U.S. Patent Application Publication 2009/0196670 describes a tape drive for use in for example a transfer printing apparatus to drive a printer ribbon. The printer ribbon is mounted on two spools each of which is driven by a respective stepper motor. A controller controls the energization of the motor such that the ribbon is transported in at least one direction between spools mounted on the spool support. The controller is operative to energize both motors to drive the spools of ribbon in the direction of ribbon transport to achieve push-pull operations. Ribbon tension is monitored to enable accurate control of ribbon supply and ribbon take-up, the ribbon tension being monitored, for example, by monitoring power supply to the two stepper motors.

U.S. Patent Application Publication 2013/0033554 describes a print station system having a chassis for housing a modular print station; a power source in communication with the print station; a controller circuit card assembly in communication with the print station; a display panel in communication with the print station; a media rewind hub; a pair of adjustable media guides connected about a base of the print station; and at least one sensor affixed to the print station base and being operable for detecting the presence and position of media passing through a media feed path of the print station system.

### SUMMARY OF THE INVENTION

An embodiment of the present invention that is described herein provides a method including receiving a first signal indicative of a first electrical current measured on a first motion assembly for moving a flexible substrate that receives droplets of a printing fluid from an image forming station to form an image thereon. A second signal indicative of a second electrical current measured on a second motion assembly for moving the flexible substrate, is received, wherein a section of the flexible substrate is moving between the first and second motion assemblies. A parameter, which is indicative of a distortion in the image, is calculated based on the first and second signals. In response to detecting, based on the parameter, an increase in the distortion, a corrective action is applied to reduce the distortion.

In some embodiments, the image has first and second axes, and the distortion includes a displacement of a pattern, in at least a section of the image, along the first axis that changes with a position along the second axis, and applying the corrective action includes reducing an increase in the displacement along the first axis. In other embodiments, the first axis is orthogonal to the second axis, and the first axis is parallel to a movement axis of the flexible substrate. In yet other embodiments, the first axis is orthogonal to the second axis, and the first axis is orthogonal to a movement axis of the flexible substrate.

In an embodiment, the image includes a first color having a first pattern and a second color having a second pattern, the distortion includes a variation in the displacement between the first pattern and the second pattern, and applying the corrective action includes reducing an increase in the variation of the displacement. In another embodiment, the distortion includes a variation in a color-to-color position difference between first and second colors of the image, and applying the corrective action includes reducing an increase in the variation of the color-to-color position difference in the image. In yet another embodiment, the distortion includes a difference between an intended position of the image on the flexible substrate and a measured position of the image on the flexible substrate, and applying the corrective action includes reducing the difference between the intended position and the measured position.

In some embodiments, at least one of the first and second motion assemblies includes a roller for moving the flexible substrate, and an electrical motor for rotating the roller, and the first electrical current is measured on the electrical motor. In other embodiments, calculating the parameter includes calculating a difference between the first and second electrical currents, such that, the calculated difference is indicative of a tension applied to the section of the flexible substrate. In yet other embodiments, applying the corrective action includes maintaining the tension applied to the section by adjusting a speed in at least one of the first and second motion assemblies.

In an embodiment, the flexible substrate includes an intermediate transfer member (ITM) for transferring the image to a target substrate in an impression station, and the method includes receiving a third signal indicative of a velocity of the ITM at the impression station, and applying the corrective action includes, in response to detecting, based on the third signal, that the velocity has changed beyond a predefined velocity range, adjusting a speed in at least one of the first and second motion assemblies. In another embodiment, the impression station includes an impression cylinder, and the third signal is indicative of a velocity of the impression cylinder.

In some embodiments, the method includes: (a) receiving: (i) a first input signal indicative of one or more first variables of the first motion assembly, and (ii) a second input signal indicative of one or more second variables of the second motion assembly, and (b) defining a virtual axis for determining, based on: (i) the third signal, and (ii) the first and second input signals, a first speed of the ITM in the first motion assembly and a second speed of the ITM in the second motion assembly.

In other embodiments, the first motion assembly includes: a first roller, a first motor and a first gear for rotating the first roller. The second motion assembly includes: a second roller, a second motor and a second gear for rotating the second roller, and applying the corrective action includes adjusting at least one of the first and second gears in response to detecting that at least one of the first and second variables exceeds a predefined threshold. In yet other embodiments, at least one of the first and second variable is selected from a list consisting of: (i) a diameter of the roller, (ii) a temperature of the roller, and (iii) a nominal speed of the roller.

There is additionally provided, in accordance with an embodiment of the present invention, a system including an interface and a processor. The interface is configured to: (i) receive a first signal indicative of a first electrical current measured on a first motion assembly for moving a flexible substrate that receives droplets of a printing fluid from an image forming station to form an image thereon, and (ii) receive a second signal indicative of a second electrical current measured on a second motion assembly for moving the flexible substrate, wherein a section of the flexible substrate is moving between the first and second motion assemblies. The processor is configured to: (i) calculate, based on the first and second signals, a parameter, which is indicative of a distortion in the image, and (ii) in response to detecting, based on the parameter, an increase in the distortion, the processor is configured to apply a corrective action to reduce the distortion.

The present invention will be more fully understood from the following detailed description of the embodiments thereof, taken together with the drawings in which:

### BRIEF DESCRIPTION OF THE DRAWINGS

FIG. 1 is a schematic side view of a digital printing system, in accordance with an embodiment of the present invention;

FIG. 2 is a block diagram that schematically illustrates a workflow for synchronizing gear ratio of motion assemblies in a digital printing system, in accordance with an embodiment of the present invention;

FIG. 3 is a graph that schematically illustrates a distortion measured on two similar images formed on a flexible substrate in different times, in accordance with an embodiment of the present invention; and

FIG. 4 is a flow chart that schematically illustrates a method for mitigating a distortion occurred in digitally printed images, in accordance with an embodiment of the present invention.

### DETAILED DESCRIPTION OF EMBODIMENTS

### Overview

Printing on a flexible substrate provides many benefits but under some circumstances an image printed on a flexible substrate may contain distortions related to, among other things, the flexibility of the substrate.

Embodiments of the present invention that are described hereinbelow provide methods and system for mitigating distortions in printed images. In some embodiments, a system for digital printing comprises a flexible intermediate transfer member (ITM) configured to receive droplets of printing fluids to form an image thereon, and to move along an axis, referred to herein as an X axis, to an impression station, so as to transfer the image to a target substrate, such as a paper sheet.

The printed image may have geometric distortions along the X axis that change with the position on a Y axis (orthogonal to the X axis), referred to herein as wave X(Y), and/or distortions along the Y axis that change with the position on the X axis, referred to herein as wave Y(X).

At least one of the wave X(Y) and wave Y(X) distortions may be caused by multiple sources, such as but not limited to, bending and stretching of the ITM, and deviation from the specified velocity (i) when receiving droplets of printing fluid from an image forming station, and (ii) when transferring the image at the impression station.

In some embodiments, the system comprises first and second motion assemblies, which are configured to move the ITM for receiving and transferring the image as described above. Each motion assembly comprises a roller and an electric motor, which is configured to rotate the roller about its rotation axis.

In some embodiments, the system comprises a processing unit, also referred to herein as a controller, which is configured to control the speed of the rollers (by controlling various components of the motion assembly, such as the motor and gear), so as to move the ITM at a specified speed. Note that each motion assembly is configured to move the ITM at a different speed, so as to maintain the moving ITM taut.

In some embodiments, when moving the ITM an interface of the controller is configured to receive: (i) a first signal indicative of a first electrical current measured on the motor of the first motion assembly, and (ii) a second signal indicative of a second electrical current measured on the motor of the second motion assembly.

In some embodiments, based on the first and second signals, the controller is configured to calculate a parameter, which is indicative of a distortion in the image. The parameter may comprise a difference or ratio between the first and second electrical currents, or any other suitable parameter.

In some embodiments, in response to detecting, based on the parameter, an increase in the distortion, the controller is configured to apply a corrective action to reduce the distortion. For example, when the difference between the first and second electrical currents exceeds a predefined upper or lower predefined threshold, the controller is configured to control at least one of the motion assemblies to adjust the speed of the respective roller(s), so as to: (i) reduce the aforementioned distortion, and/or (ii) prevent formation of a new distortion.

In some embodiments, the controller is configured to receive a third signal indicative of the velocity of the ITM at the impression station. The velocity may be measured using a motion encoder integrated with the impression station, and the measured velocity may be filtered for smoothing the third signal. Based on the velocity of the third signal, the controller is configured to determine a gear ratio between the gears of the first and second motion assemblies. Moreover, in response to detecting a variation in the ITM velocity at the impression station, the controller is configured to adjust the speed of the roller in at least one of the first and second motion assemblies.

In other embodiments, in addition to the signals described above, the controller is configured to receive one or more signals indicative of the velocity of the ITM using any sort of one or more encoders disposed at any suitable position(s) along the path of the ITM. Moreover, the ITM may have an encoder, which is integrated thereon or therein or therewith, and one or more suitable sensor(s) disposed along the path of the ITM, and configured to produce respective signal(s) indicative of the position of sections of the ITM. Based on the respective signals, the controller is configured to estimate the speed of the ITM along the path.

The disclosed techniques mitigate various types of distortions in images printed on a flexible substrate. Moreover, the disclosed techniques improve productivity of the printing system by automatically calibrating the ITM speed (without stopping the system operation) during the printing process. Such calibration may be needed, for example, when the diameter of one or more: (i) roller(s) of the motion assemblies and/or (ii) cylinder(s) of the impression station, is changing in response to altering temperature thereof.

The embodiments and principles described above are applicable to: (i) printing systems using an intermediate transfer member for transferring images to a target substrate (as described above), and (ii) printing systems for printing directly on a flexible target substrate.

Furthermore, the disclosed techniques may be used, mutatis mutandis, for improving quality and reliability of systems for reading content from a flexible media.

### System Description

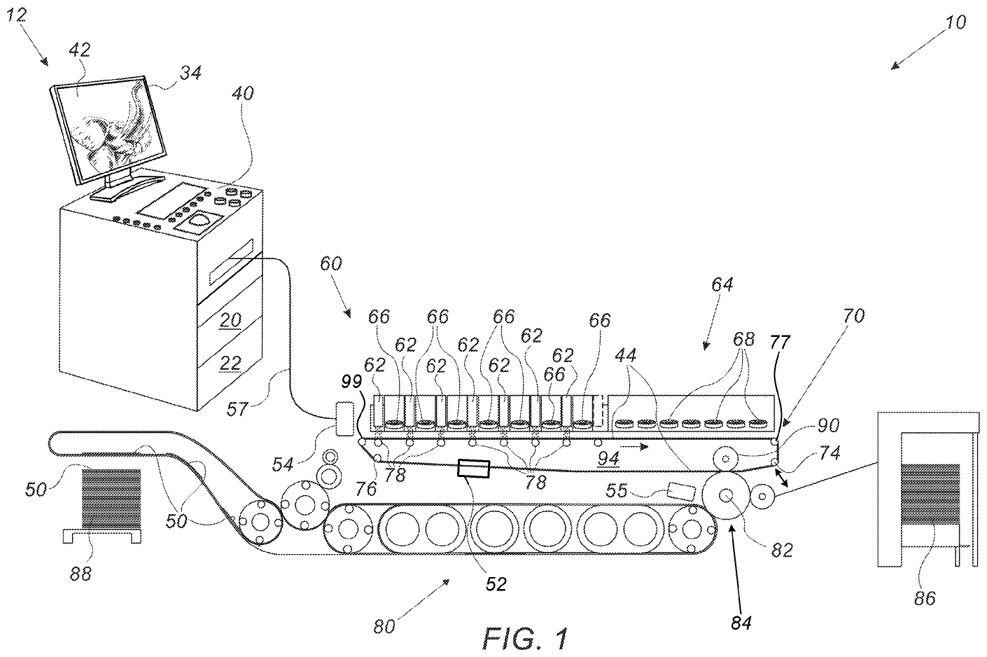

FIG. 1 is a schematic side view of a digital printing system 10, in accordance with an embodiment of the present invention. In some embodiments, system 10 comprises a rolling flexible blanket 44 that cycles through an image forming station 60, a drying station 64, an impression station 84 and a blanket treatment station 52. In the context of the present invention and in the claims, the terms “blanket” and “intermediate transfer member (ITM)” are used interchangeably and refer to a flexible member comprising one or more layers used as an intermediate member configured to receive an ink image and to transfer the ink image to a target substrate, as will be described in detail below.

In an operative mode, image forming station 60 is configured to form a mirror ink image, also referred to herein as “an ink image” (not shown) or as an “image” for brevity, of a digital image 42 on an upper run of a surface of blanket 44. Subsequently, when reaching the impression station 84, the ink image is transferred to a target substrate, (e.g., a paper, a folding carton, a multilayered polymer, or any suitable flexible package in a form of sheets or continuous web) located under a lower run of blanket 44.

In the context of the present invention, the term “run” refers to a length or segment of blanket 44 between any two given rollers over which blanket 44 is guided.

In some embodiments, during installation, blanket 44 may be adhered to form a continuous blanket loop (not shown). An example of a method and a system for the installation of the seam is described in detail in U.S. Provisional Application 62/532,400, whose disclosure is incorporated herein by reference.

In some embodiments, image forming station 60 typically comprises multiple print bars 62, each mounted (e.g., using a slider) on a frame (not shown) positioned at a fixed height above the surface of the upper run of blanket 44. In some embodiments, each print bar 62 comprises a strip of print heads substantially as wide as the printing area on blanket 44 and comprises individually controllable print nozzles.

In some embodiments, image forming station 60 may comprise any suitable number of bars 62, each bar 62 may contain a printing fluid, such as an aqueous ink of a different color. The ink typically has visible colors, such as but not limited to cyan, magenta, red, green, blue, yellow, black and white. In the example of FIG. 1, image forming station 60 comprises seven print bars 62, but may comprise, for example, four print bars 62 having any selected colors such as cyan (C), magenta (M), yellow (Y) and black (K).

In some embodiments, the print heads are configured to jet ink droplets of the different colors onto the surface of blanket 44 so as to form the ink image (not shown) on the surface of blanket 44.

In some embodiments, different print bars 62 are spaced from one another along the movement axis, also referred to herein as moving direction of blanket 44, represented by an arrow 94. In this configuration, accurate spacing between bars 62, and synchronization between directing the droplets of the ink of each bar 62 and moving blanket 44 are essential for enabling correct placement of the image pattern.

In the context of the present disclosure and in the claims, the terms “inter-color pattern placement,” “pattern placement accuracy,” color-to-color registration,” “C2C registration,” “color to color position difference,” “bar to bar registration,” and “color registration” are used interchangeably and refer to any placement accuracy of two or more colors relative to one another.

In some embodiments, system 10 comprises heaters 66, such as hot gas or air blowers and/or infrared-based heaters with gas or air blowers for flowing gas or air at any suitable temperature. Heaters 66 are positioned in between print bars 62, and are configured to partially dry the ink droplets deposited on the surface of blanket 44. This air flow between the print bars may assist, for example, (i) in reducing condensation at the surface of the print heads and/or in handling satellites (e.g., residues or small droplets distributed around the main ink droplet), and/or (ii) in preventing blockage of the inkjet nozzles of the print heads, and/or (iii) in preventing the droplets of different color inks on blanket 44 from undesirably merging into one another. In some embodiments, system 10 comprises drying station 64, configured to direct infrared radiation and/or to blow hot air (or another gas) onto the surface of blanket 44. In some embodiments, drying station 64 may comprise infrared-based illumination assemblies (not shown) and/or air blowers 68 or any other suitable drying apparatus.

In drying station 64, the ink image formed on blanket 44 is exposed to radiation and/or to hot air in order to dry the ink more thoroughly, evaporating most or all of the liquid carrier and leaving behind only a layer of resin and coloring agent which is heated to the point of being rendered tacky ink film.

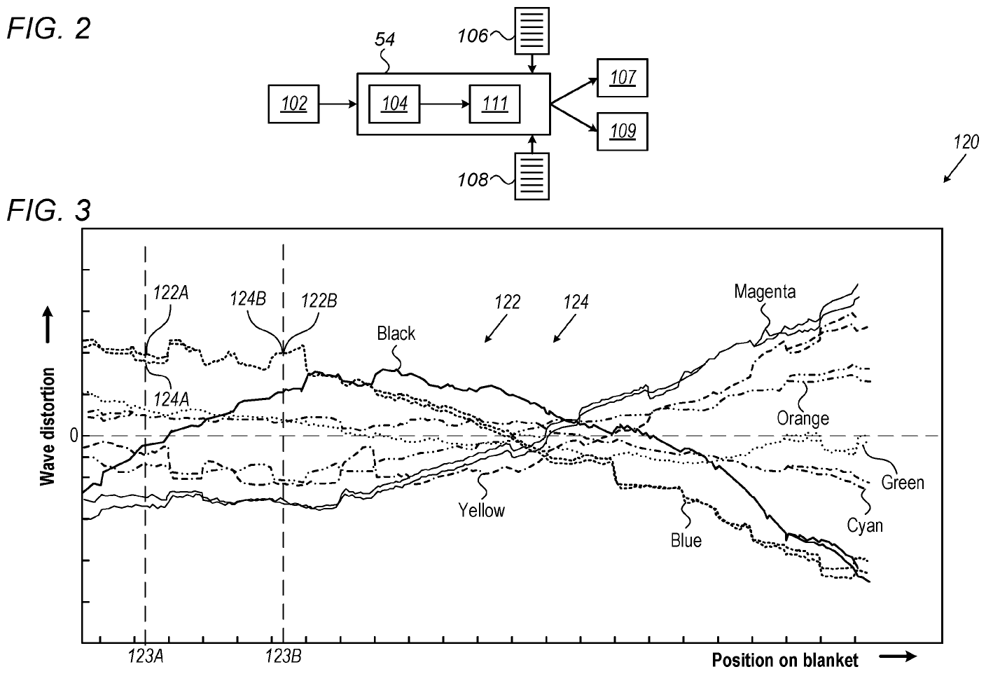

In some embodiments, system 10 comprises a blanket module 70 comprising a rolling flexible ITM, such as a blanket 44. In some embodiments, blanket module 70 comprises one or more rollers 78, wherein at least one of rollers 78 comprises a motion encoder (not shown), which is configured to record the position of blanket 44, so as to control the position of a section of blanket 44 relative to a respective print bar 62. Note that one or more motion encoders may be integrated with additional rollers and other moving components of system 10 as will be described in detail in FIGS. 2-4 below.

In some embodiments, the aforementioned motion encoders typically comprise at least one rotary encoder configured to produce rotary-based position signals indicative of an angular displacement of the respective roller. Note that in the context of the present invention and in the claims, the terms “indicative of” and “indication” are used interchangeably.

Additionally or alternatively, blanket 44 may comprise an integrated encoder (not shown) for controlling the operation of various modules of system 10. One implementation of the integrated motion encoder is described in detail, for example, in U.S. Provisional Application 62/689,852, whose disclosure is incorporated herein by reference.

In some embodiments, blanket 44 is guided over rollers 76, 78 and other rollers described herein, and over a powered tensioning roller, also referred to herein as a dancer assembly 74. Dancer assembly 74 is configured to control the length of slack in blanket 44 and its movement is schematically represented by a double sided arrow. Furthermore, any stretching of blanket 44 with aging would not affect the ink image placement performance of system 10 and would merely require the taking up of more slack by tensioning dancer assembly 74.

In some embodiments, dancer assembly 74 may be motorized. The configuration and operation of rollers 76 and 78 are described in further detail, for example, in U.S. Patent Application Publication 2017/0008272 and in the above-mentioned PCT International Publication WO 2013/132424, whose disclosures are all incorporated herein by reference.

In some embodiments, system 10 comprises a blanket tension drive roller (BTD) 99 and a blanket control drive roller (BCD) 77, which are powered by respective first and second motors, typically electric motors (not shown) and are configured to rotate about their own first and second axes, respectively.

In some embodiments, BTD 99 is configured to rotate at a first speed, and BCD 77 is configured to rotate at a second speed, which is typically larger than the first speed, so as to maintain the upper run of blanket 44 taut when passing adjacent to image forming station 60. In some embodiments, the first and second speeds are monitored and controlled so as to prevent formation of distortions, e.g., along the movement axis of blanket 44, as will be described in detail in FIGS. 2-4 below.

In some embodiments, system 10 may comprise one or more tension sensors (not shown) disposed at one or more positions along blanket 44. The tension sensors may be integrated in blanket 44 or may comprise sensors external to blanket 44 using any other suitable technique to acquire signals indicative of the mechanical tension applied to blanket 44. In some embodiments, processor 20 and additional controllers of system 10 are configured to receive the signals produced by the tension sensors, so as to monitor the tension applied to blanket 44 and to control the operation of dancer assembly 74.

In impression station 84, blanket 44 passes between an impression cylinder 82 and a pressure cylinder 90, which is configured to carry a compressible blanket. In some embodiments, a motion encoder is integrated with at least one of impression cylinder 82 and pressure cylinder 90.

In some embodiments, system 10 comprises a control console 12, which is configured to control multiple modules of system 10, such as blanket module 70, image forming station 60 located above blanket module 70, and a substrate transport module 80, which is located below blanket module 70 and comprises one or more impression stations as will be described below.

In some embodiments, console 12 comprises a processor 20, typically a general-purpose processor, with suitable front end and interface circuits for interfacing with controllers of dancer assembly 74 and with a controller 54, via a cable 57, and for receiving signals therefrom. Additionally or alternatively, console 12 may comprise any suitable type of an application-specific integrated circuit (ASIC) and/or a digital signal processor (DSP) and/or any other suitable sort of processing unit configured to carry out any sort of processing for data processed in system 10.

In some embodiments, controller 54, which is schematically shown as a single device, may comprise one or more electronic modules mounted on system 10 at predefined locations. At least one of the electronic modules of controller 54 may comprise an electronic device, such as control circuitry or a processor (not shown), which is configured to control various modules and stations of system 10. In some embodiments, processor 20 and the control circuitry may be programmed in software to carry out the functions that are used by the printing system, and store data for the software in a memory 22. The software may be downloaded to processor 20 and to the control circuitry in electronic form, over a network, for example, or it may be provided on non-transitory tangible media, such as optical, magnetic or electronic memory media.

In some embodiments, console 12 comprises a display 34, which is configured to display data and images received from processor 20, or inputs inserted by a user (not shown) using input devices 40. In some embodiments, console 12 may have any other suitable configuration, for example, an alternative configuration of console 12 and display 34 is described in detail in U.S. Pat. No. 9,229,664, whose disclosure is incorporated herein by reference.

In some embodiments, processor 20 is configured to display on display 34, a digital image 42 comprising one or more segments (not shown) of image 42 and/or various types of test patterns that may be stored in memory 22.

In some embodiments, blanket treatment station 52, also referred to herein as a cooling station, is configured to treat the blanket by, for example, cooling it and/or applying a treatment fluid to the outer surface of blanket 44, and/or cleaning the outer surface of blanket 44. At blanket treatment station 52, the temperature of blanket 44 can be reduced to a desired temperature-level before blanket 44 enters into image forming station 60. The treatment may be carried out by passing blanket 44 over one or more rollers or blades configured for applying cooling and/or cleaning and/or treatment fluid on the outer surface of the blanket.

In some embodiments, blanket treatment station 52 may further comprise one or more bars (not shown) positioned adjacent to print bars 62, so that the treatment fluid may additionally or alternatively be applied to blanket 44 by jetting.

In some embodiments, processor 20 is configured to receive, e.g., from temperature sensors (not shown), signals indicative of the surface temperature of blanket 44, so as to monitor the temperature of blanket 44 and to control the operation of blanket treatment station 52. Examples of such treatment stations are described, for example, in PCT International

Publications WO 2013/132424 and WO 2017/208152, whose disclosures are all incorporated herein by reference.

In the example of FIG. 1, station 52 is mounted between impression station 84 and image forming station 60, yet, station 52 may be mounted adjacent to blanket 44 at any other or additional one or more suitable locations between impression station 84 and image forming station 60. As described above, station 52 may additionally or alternatively be mounted on a bar adjacent to image forming station 60.

In the example of FIG. 1, impression cylinder 82 impresses the ink image onto the target flexible substrate, such as an individual sheet 50, conveyed by substrate transport module 80 from an input stack 86 to an output stack 88 via impression cylinder 82. In the present example, a rotary encoder (not shown) is integrated with impression cylinder 82, as will be described in detail below.

In some embodiments, the lower run of blanket 44 selectively interacts at impression station 84 with impression cylinder 82 to impress the image pattern onto the target flexible substrate compressed between blanket 44 and impression cylinder 82 by the action of pressure of pressure cylinder 90. In the case of a simplex printer (i.e., printing on one side of sheet 50) shown in FIG. 1, only one impression station 84 is needed.

In other embodiments, module 80 may comprise two or more impression cylinders (not shown) so as to permit one or more duplex printing. The configuration of two impression cylinders also enables conducting single sided prints at twice the speed of printing double sided prints. In addition, mixed lots of single and double sided prints can also be printed. In alternative embodiments, a different configuration of module 80 may be used for printing on a continuous web substrate. Detailed descriptions and various configurations of duplex printing systems and of systems for printing on continuous web substrates are provided, for example, in U.S. Pat. Nos. 9,914,316 and 9,186,884, in PCT International Publication WO 2013/132424, in U.S. Patent Application Publication 2015/0054865, and in U.S. Provisional Application 62/596,926, whose disclosures are all incorporated herein by reference.

As briefly described above, sheets 50 or continuous web substrate (not shown) are carried by module 80 from input stack 86 and pass through the nip (not shown) located between impression cylinder 82 and pressure cylinder 90. Within the nip, the surface of blanket 44 carrying the ink image is pressed firmly, e.g., by compressible blanket (not shown), of pressure cylinder 90 against sheet 50 (or other suitable substrate) so that the ink image is impressed onto the surface of sheet 50 and separated neatly from the surface of blanket 44. Subsequently, sheet 50 is transported to output stack 88.

In the example of FIG. 1, rollers 78 are positioned at the upper run of blanket 44 and are configured to maintain blanket 44 taut when passing adjacent to image forming station 60. Furthermore, it is particularly important to control the speed of blanket 44 below image forming station 60 so as to obtain accurate jetting and deposition of the ink droplets, thereby placement of the ink image, by forming station 60, on the surface of blanket 44.

In some embodiments, impression cylinder 82 is periodically engaged with and disengaged from blanket 44, so as to transfer the ink images from moving blanket 44 to the target substrate passing between blanket 44 and impression cylinder 82. In some embodiments, system 10 is configured to apply torque to blanket 44 using the aforementioned rollers and dancer assemblies, so as to maintain the upper run taut and to substantially isolate the upper run of blanket 44 from being affected by mechanical vibrations occurring in the lower run.

In some embodiments, system 10 comprises an image quality control station 55, also referred to herein as an automatic quality management (AQM) system, which serves as a closed loop inspection system integrated in system 10. In some embodiments, image quality control station 55 may be positioned adjacent to impression cylinder 82, as shown in FIG. 1, or at any other suitable location in system 10.

In some embodiments, image quality control station 55 comprises a camera (not shown), which is configured to acquire one or more digital images of the aforementioned ink image printed on sheet 50. In some embodiments, the camera may comprises any suitable image sensor, such as a Contact Image Sensor (CIS) or a Complementary metal oxide semiconductor (CMOS) image sensor, and a scanner comprising a slit having a width of about one meter or any other suitable width.

In the context of the present disclosure and in the claims, the terms “about” or “approximately” for any numerical values or ranges indicate a suitable dimensional tolerance that allows the part or collection of components to function for its intended purpose as described herein.

In some embodiments, station 55 may comprise a spectrophotometer (not shown) configured to monitor the quality of the ink printed on sheet 50.

In some embodiments, the digital images acquired by station 55 are transmitted to a processor, such as processor 20 or any other processor of station 55, which is configured to assess the quality of the respective printed images. Based on the assessment and signals received from controller 54, processor 20 is configured to control the operation of the modules and stations of system 10. In the context of the present invention and in the claims, the term “processor” refers to any processing unit, such as processor 20 or any other processor or controller connected to or integrated with station 55, which is configured to process signals received from the camera and/or the spectrophotometer of station 55. Note that the signal processing operations, control-related instructions, and other computational operations described herein may be carried out by a single processor, or shared between multiple processors of one or more respective computers.

In some embodiments, station 55 is configured to inspect the quality of the printed images and test pattern so as to monitor various attributes, such as but not limited to full image registration with sheet 50, color-to-color (CTC) registration, printed geometry, image uniformity, profile and linearity of colors, and functionality of the print nozzles. In some embodiments, processor 20 is configured to automatically detect geometrical distortions or other errors in one or more of the aforementioned attributes. For example, processor 20 is configured to compare between a design version (also referred to herein as a “master” or a “source image” of a given digital image and a digital image of the printed version of the given image, which is acquired by the camera.

In other embodiments, processor 20 may apply any suitable type image processing software, e.g., to a test pattern, for detecting distortions indicative of the aforementioned errors. In some embodiments, processor 20 is configured to analyze the detected distortion in order to apply a corrective action to the malfunctioning module, and/or to feed instructions to another module or station of system 10, so as to compensate for the detected distortion.

In some embodiments, system 10 may print testing marks (not shown) or other suitable features, for example at the bevels or margins of sheet 50. By acquiring images of the testing marks, station 55 is configured to measure various types of distortions, such as C2C registration, image-to-substrate registration, different width between colors referred to herein as “bar to bar width delta” or as “color to color width difference”, various types of local distortions, and front-to-back registration errors (in duplex printing). In some embodiments, processor 20 is configured to: (i) sort out, e.g., to a rejection tray (not shown), sheets 50 having a distortion above a first predefined set of thresholds, (ii) initiate corrective actions for sheets 50 having a distortion above a second, lower, predefined set of threshold, and (iii) output sheets 50 having minor distortions, e.g., below the second set of thresholds, to output stack 88.

In some embodiments, processor 20 is further configured to detect, e.g., by analyzing a pattern of suitable printed features, additional geometric distortion such as scaling up or down, skew, or a wave distortion occurred in at least one of: (i) an axis parallel to the movement axis of blanket 44, and (ii) an axis orthogonal to the movement axis of blanket 44.

In some embodiments, processor 20 is configured to detect, based on signals received from the spectrophotometer of station 55, deviations in the profile and linearity of the printed colors.

In some embodiments, the processor of station 55 is configured to decide whether to stop the operation of system 10, for example, in case the density of distortions is above a specified threshold. The processor of station 55 is further configured to initiate a corrective action in one or more of the modules and stations of system 10, as described above. As will be described below, the corrective action may be carried out on-the-fly (while system 10 continue the printing process), or offline, by stopping the printing operation and fixing the problem in a respective modules and/or station of system 10. In other embodiments, any other processor or controller of system 10 (e.g., processor 20 or controller 54) is configured to start a corrective action or to stop the operation of system 10 in case the density of distortions is above a specified threshold.

Additionally or alternatively, processor 20 is configured to receive, e.g., from station 55, signals indicative of additional types of distortions and problems in the printing process of system 10. Based on these signals processor 20 is configured to automatically estimate the level of pattern placement accuracy and additional types of distortions and/or defects not mentioned above. In other embodiments, any other suitable method for examining the pattern printed on sheets 50 (or on any other substrate described above), can also be used, for example, using an external (e.g., offline) inspection system, or any type of measurements jig and/or scanner. In these embodiments, based on information received from the external inspection system, processor 20 is configured to initiate any suitable corrective action and/or to stop the operation of system 10.

The configuration of system 10 is simplified and provided purely by way of example for the sake of clarifying the present invention. The components, modules and stations described in printing system 10 hereinabove and additional components and configurations are described in detail, for example, in U.S. Pat. Nos. 9,327,496 and 9,186,884, in PCT International Publications WO 2013/132438, WO 2013/132424 and WO 2017/208152, in U.S. Patent Application Publications 2015/0118503 and 2017/0008272, whose disclosures are all incorporated herein by reference.

The particular configurations of system 10 is shown by way of example, in order to illustrate certain problems that are addressed by embodiments of the present invention and to demonstrate the application of these embodiments in enhancing the performance of such systems. Embodiments of the present invention, however, are by no means limited to this specific sort of example systems, and the principles described herein may similarly be applied to any other sorts of printing systems.

### Using a Virtual Axis for Synchronizing Gear Ratio of BCD and BTD Rollers with Impression Cylinder Speed

FIG. 2 is a block diagram that schematically illustrates a workflow for synchronizing the gear ratio of BCD 77 and BTD 99 with the speed of impression cylinder 82 using a virtual axis 111, in accordance with an embodiment of the present invention. In some embodiments, the workflow may be implemented so as to maintain blanket 44 taut while moving at a predefined speed (or within a range of speeds) at least between BTD 99 and impression station 84.

In some embodiments, system 10 comprises a rotary encoder 102, which is integrated with impression cylinder 82 (FIG. 1). Encoder 102 is configured to produce rotary-based position signals indicative of an angular displacement of impression cylinder 82. In some embodiments, encoder 102 is configured to produce the position signals at a predefined frequency, in the present example a frequency of about 1 KHz.

In some embodiments, system 10 comprises a smoothing filter 104, in the present example a low-pass filter, which is applied to the position signals received from encoder 102 for filtering-out frequencies larger than a predefined cutoff threshold, e.g., about 50 Hz. Smoothing filter 104 may be implemented in any suitable device of system 10, such as in processor 20 and/or controller 54, and may apply moving average or any other suitable technique for smoothing the position signals received from encoder 102.

In some embodiments, system 10 comprises a virtual axis 111, which may be implemented as a software module in controller 54 or in any other suitable device. Virtual axis 111 is configured to receive the position signals from smoothing filter 104, and to produce signals indicative of the angular position and the speed of impression cylinder 82.

In some embodiments, controller 54 is configured to receive an input 106 comprising parameters associated with BCD 77, and an input 108 comprising parameters associated with BTD 99. Input 106 may comprise any suitable parameters, such as but not limited to: (i) nominal diameter of BCD 77, (ii) compensation for changes in the diameter of BCD 77, e.g., based on estimated or measured temperature of BCD 77, and (iii) target speed of BCD 77 (typically rotational speed, but can also be an estimation of a linear speed). Similarly, input 108 may comprise the nominal diameter of BTD 99 and other parameters, such as the estimated or measured temperature on BTD 99, and the target speed of BTD 99 (typically rotational speed, but can also be an estimation of a linear speed).

In some embodiments, in addition to compensation for changes in the diameter of BCD 77, controller 54 is configured to compensate for additional variations, such as but not limited to variations in the effective thickness of blanket 44, the effective spring constant of blanket 44 that resist the tension applied to blanket 44.

In some embodiments, based on: (i) the position and rotational speed of impression cylinder 82, and (ii) inputs 106 and 108, controller 54 is configured to determine a BCD gear ratio (BCDGR) 107, and a BTD gear ratio (BTDGR) 109, which are physical axes of BCG 77 and BTG 99, respectively. For example, in order to maintain blanket 44 taut between BTD 99 and impression station 84, controller 54 may determine a ratio of 1.1, or 1.01, or 1.001 or any other suitable ratio, between BCDGR 107 and BTDGR 109.

In such embodiments, BCD 77 rotates about its fixed axis with a first angular speed (e.g., the nominal rotational speed of BCD 77 is between about 5 rounds per second and 6 rounds per second and) in the present example, about 5.42 rounds per second. Note that based on the gear ratios described above, BTD 99 rotates about its fixed axis with a second angular speed at the same time interval that BCD 77 rotates, but at a different rotational speed. For example, when BCD 77 rotates at a nominal rotation speed of about 5.42 rounds per second, BTD 99 rotates at a nominal rotational speed of about 5.414 rounds per second, which is calculated by dividing the aforementioned nominal rotational speed (5.42 rounds per second) of BCD 77, by the gear ratio of 1.001 (5.42/1.001).

In the context of the present disclosure and in the claims, the signal receiving, signal processing and process control operations may be carried out by controller 54 and/or processor 20, or may be partitioned therebetween. For example, when describing embodiments carried out by controller 54, the same embodiments may be carried out by processor 20.

In some embodiments, by applying the workflow of FIG. 2, controller 54 is configured to synchronize the linear speed of blanket 44 passing through BTD 99, BCD 77 and impression cylinder 82, so as to maintain blanket 44 taut: (i) when passing along the upper run of blanket 44 in the moving direction of blanket 44, between BTD 99 and BCD 77, for forming the image on blanket 44, and (ii) when passing though impression station 84, for transferring the image from blanket 44 to sheet 50. In such embodiments, controller 54 is configured to carry out the aforementioned synchronization, by defining the speed of blanket 44 so that at each revolution of blanket 44, the image formed on blanket 44 falls on the same section of impression cylinder 82 for being transferred to sheet 50. Note that this synchronization improves the matching between images printed by system 10.

In some embodiments, controller 54 is further configured to apply the operation of dancer assembly 74 to the calculation of the rotational speeds of BTD 99, BCD 77 and impression cylinder 82.

In some embodiments, dancer assembly 74 comprises one or more load cells (not shown), each load call typically comprising a piezoelectric element, which is configured for measuring the pressure applied to blanket 44 by dancer assembly 74. The load cell may function similarly to a weight measurement device, which is configured, in response to a given pressure applied to the load cell, to output a signal indicative of the given pressure. The given pressure is also indicative of the tension applied to blanket 44.

In the present example, dancer assembly comprises two load cells mounted at the two respective ends of dancer assembly 74. Note that, because blanket 44 is flexible, the pressure and tension applied by dancer assembly 74 may alter the length of blanket 44 (e.g., due to an elastic deformation).

In some embodiments, controller 54 controls dancer assembly 74 to maintain a preassigned (e.g., constant) tension to blanket 44. Moreover, based on the signals received from the two load cells mounted on dancer assembly 74, controller 54 is configured to estimate the length of blanket 44 and to adjust the rotational speed of BCD 77 and BTD 99 based on the estimated length. Moreover, controller 54 is configured to control the position of one or more elements of dancer assembly 74, so as to obtain the preassigned tension to blanket 44 and to synchronize the motion of blanket 44 so that the image printed on blanket 44 will be transferred to sheet 50 at the intended section of impression cylinder 82.

In some embodiments, when system 10 moves blanket 44, controller 54 is configured to receive a first signal indicative of a first electrical current measured on the motor of BTD 99. Controller 54 is further configured to receive a second signal indicative of a second electrical current, measured on the motor of BCD 77 The second electrical current may be different, e.g., larger, compared to the first electrical current. In some embodiments, the first and second electrical currents are typically indicative of first and second respective torque forces applied to blanket 44 via BTD 99 and BCD 77, respectively.

In other embodiments, at least one of the first and second signals may be received from one or more other devices, which are configured to measure tension applied to blanket 44. For example, the flexibility of blanket 44 may be translated to a constant of a spring, which may be calculated based on the distance measured between two predefined features of blanket 44. For example, blanket 44 may comprise a fabric having fibers arranged along the movement direction of blanket 44. In such embodiments, system 10 may comprise one or more sensors, which are configured to output signals indicative of the position of given fibers of blanket 44. Based on the signals, controller 54 and/or processor 20 are configured to estimate the length of blanket 44, and to adjust the tension applied to blanket 44 (e.g., tension applied to the upper run, between BTD 99 and BCD 77) and/or the speed of blanket 44 in the movement direction, as described above.

In some embodiments, controller 54 is configured to calculate, based on the first and second signals, a parameter, which is indicative of a distortion, such as but not limited to: (i) a wave X(Y) distortion, (ii) a wave Y(X) distortion, (i) C2C registration error between two or more colors of the image formed on blanket 44, (iv) a deviation in the pattern placement accuracy (PPA) of at least a section of the image formed on blanket 44 and transferred to sheet 50, referred to herein as image to substrate registration error, or (v) any combination of the above.

In some embodiments, the parameter may comprise the difference between the aforementioned first and second electrical currents, which is indicative of torque, and therefore of the tension, applied to blanket 44 when the blanket is moved in the moving direction, between BTD 99 and BCD 77. Note that in the present example, the current is determined based on the printing application, and therefore, the maximal current is normalized to 100%, and the difference between the first and second electrical currents is measured by percentage normalized to the maximal current. For example, the second electrical current measured on the motor of BCD 77 may be normalizing to about 75% of the maximal current, and the first electrical current measured on the motor of BTD 99 may be normalizing to about 42% of the maximal current. In this example, the difference between the first and second electrical currents is about 33%.

In some embodiments, controller 54 is configured to hold control thresholds for the difference between the first and second electrical currents. For example, controller 54 may detect a degradation in the X(Y) wave distortion, because blanket 44 is not sufficiently taut when the difference between the first and second electrical currents is smaller than a certain threshold (e.g. about 29%) or larger than a certain threshold (e.g. about 33%). In such embodiments, processor 20 may apply a corrective action, such as adjusting the speed of at least one of the motors of BCD 77 and BTD 99, so as to have the required difference between the first and second electrical currents (e.g. between about 29% and 33%). Note that the monitoring and corrective action described above may be carried out at any predefined timing during the printing cycle, preferably before applying the image to blanket 44 by image forming station. Thus, processor 20 is configured to control image forming station 60 to apply the image to blanket 44 only after obtaining, between the first and second electrical currents, a stable predefined difference (e.g. between about 29% and 33%).

### Mitigating Wave Distortion by Measuring Electrical Currents in BCD And BTD Motors

FIG. 3 is a graph 120 that schematically illustrates a wave distortion of multiple color measured on two similar images formed on blanket 44 at a time difference of about four days, in accordance with an embodiment of the present invention.

In some embodiments, the wave distortion was measured and calculated using any suitable inspection technique, such as using image quality control station 55 described in FIG. 1 above. The vertical axis of graph 120 represents a distortion error, in the present example the wave distortion error.

The wave distortion error may occur along the movement direction of blanket 44, referred to herein as an X axis, that change with the position on a Y axis (orthogonal to the X axis), referred to herein as wave X(Y) and shown in graph 120. Note that the wave distortion is calculated based on the distance measured between the intended position and the measured position of a given pattern of each color of the printed image. In the context of the present disclosure, the term “intended position” refers to the position of the given pattern of each color in the design of the image intended to be printed by system 10.

In the example of graph 120, the distance is measured relative to the horizontal dashed line, which is extended from the number “0” of the wave distortion axis, and represents zero distortion. The curves above and below the dashed line are indicative of the direction of the deviation of the measured positions of the pattern relative to the intended position.

In other embodiments, a different graph (not shown in FIG. 3) may show a distortion along Y axis that changes with the position on X axis, referred to herein as wave Y(X).

The wave distortion may be caused by various errors, such as but not limited to: (i) a deviation from the specified motion profile of blanket 44, (ii) a deviation from the specified relative speed between blanket 44 and sheet 50 at impression station 84, (iii) a deviation of the profile (e.g., position, shape and orientation) of print bar 62 relative to blanket 44, and (iv) other deviations cause by altering temperature of one or more components and/or modules and/or stations of system 10.

In the example of FIG. 3, graph 120 comprises graphs 122 and 124 of the two respective similar images having seven different colors of ink (in the present example, black, blue, cyan, green, magenta, orange and yellow).

In some embodiments, the two similar images have been formed at a time difference of about four days, e.g., during a continuous operation of system 10. Respective graphs 122 and 124 are shown overlaid on graph 120 and are indicative of the measured wave X(Y) distortion of each color in each of the two images.

The errors described above, and additional errors, may result in a wavy pattern of the printed features as shown in graph 120. Note that typically the wavy pattern has two components: (i) a common wave of all colors, e.g., due to the aforementioned deviation at impression station 84, and (ii) different waves formed in each color image are caused, for example, due to temporary variation in the velocity of and tension applied to blanket 44, for example, when the upper run passes between print bars of different colors.

In some embodiments, controller 54 is configured to control the motors of BCD 77 and BTD 99 to retain a difference (e.g. of about 32%) between the measured first and second electrical currents, as described in FIG. 2 above. In the present example, the aforementioned difference is maintained for at least four days, so as to maintain blanket 44 taut when system 10 is printing images during this period of time.

As shown in graph 120, the profile of wave distortion is maintained for each color in both images. For example, at a position 123A on blanket 44, the measured wave distortion of the blue color of ink, shown in points 122A and 124A of respective graphs 122 and 124, has a minor difference (e.g., between a few microns and about 10 μm). Similarly, at a different position 123B on blanket 44, the wave distortion of the blue color is identical in both images, as shown by points 122B and 124B of graphs 122 and 124, respectively.

In some embodiments, controller 54 is configured to maintain the profile of the wave distortion of each color of ink stable over time. In the present example, the wave profile is maintained by controlling the difference between the measured electrical currents of the motors of BCD 77 and BTD 99, within a suitable specified range, such as the range described in FIG. 2 above.

In some embodiments, processor 20 may apply various techniques for correcting a wave distortion in a printed image. Some implementations of wave distortion correction are described in detail, for example, in U.S. Patent Application Publication 2019/0152218, and in U.S. Provisional Application 62/717,957, whose disclosures are incorporated herein by reference. In some embodiments, after correcting the wave distortion, the disclosed techniques may be applied to maintain the correction stable over the operational time of system 10. Moreover, the disclosed techniques may retain the stability of correction for both wave X(Y) and wave Y(X) described above.

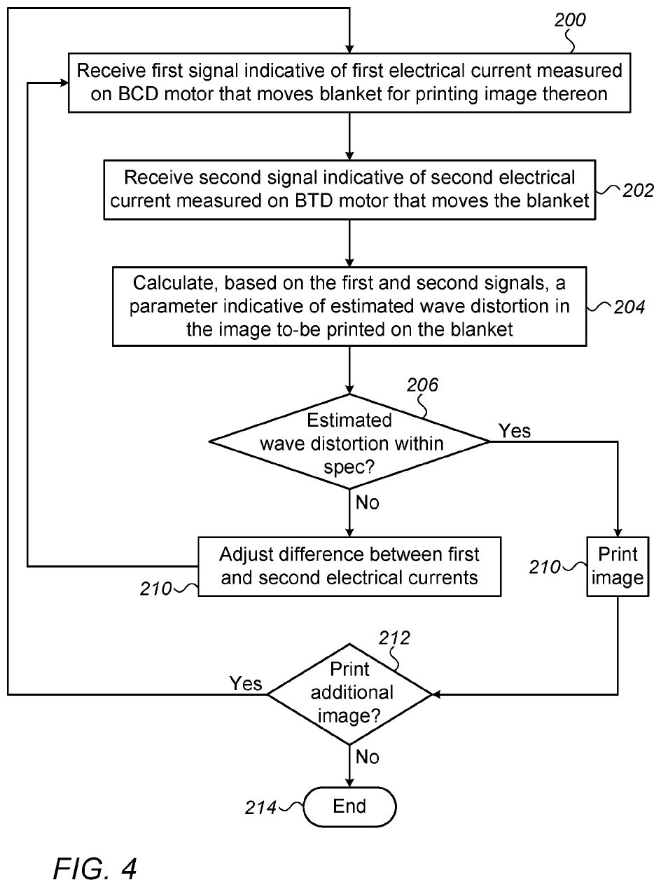

FIG. 4 is a flow chart that schematically illustrates a method for improving stability of wave distortion over time, in accordance with an embodiment of the present invention. The method begins at a first signal receiving step 200 with receiving (e.g., by controller 54) a first signal indicative of a first electrical current measured on the motor of BCD 77 that moves blanket 44 for printing an image thereon. At a second signal receiving step 202, controller 54 receives a second signal indicative of a second electrical current measured on the motor of BTD 99 that moves blanket 44 together with BCD 77. In some embodiments, controller 54 and/or processor 20 may hold a predefined process window having, inter alia, a threshold of the difference between the first and second measured currents. In such embodiments, controller 54 and/or processor 20 are configured to hold the operation of system 10 when the difference between the first and second measured currents is larger than the threshold.

At a parameter calculation step 204, controller 54 calculates, based on the first and second signals, a parameter indicative of the estimated wave distortion in the image intended to be printed on blanket 44. In some embodiments, controller 54 is configured to calculate, based on the difference between the first and second electrical currents, one or more indications of the estimated wave distortion. Such wave distortions may be related to errors of pattern placement accuracy (PPA) during the printing process of the image in system 10.

In some embodiments, when monitoring the difference between the first and second electrical currents, controller 54 is configured to hold thresholds (e.g., about 29% and 33% of the maximal electrical current as described in FIG. 2 above), which are indicative of whether the estimated wave distortion is within the specification of the image forming process, or whether the estimated wave distortion exceeds the specification. At a first decision step 206, controller 54 compares between: (i) the calculated difference between the first and second electrical currents, and (ii) the threshold described above, so as to check whether or not the estimated wave distortion is within the specification of the image forming process.

In some embodiments, in case the estimated wave distortion exceeds the specification of the image forming process, the method proceeds to an electrical current adjustment step 208. In some embodiments, at step 208, controller 54 adjusts the speed of at least one of BCD 77 and BTD 99, so as to obtain the difference between the first and second electrical currents within the specified range, e.g., between about 29% and 33%, as described in FIG. 2 above.

In some embodiments, after step 208, the method loops back to step 200 for receiving the first and second signals, and checking (e.g., at step 206) whether the estimated distortion is within the specification of the printing process.

In other embodiments, in case the estimated wave distortion is within the specification of the image forming process, the method proceeds to an image printing step 210, with controlling the stations of system 10 to apply ink droplets to blanket 44, so as to form the image thereon.

At a second decision step 212, processor 20 checks, based on the printing plan of system 10, whether or not to print an additional image on blanket 44. In case the printing plan requires printing an additional image on blanket 44, the method loops back to step 200 for receiving the signals, estimating whether the estimated wave distortion is within the specification of the printing process, and if needed, adjusting the speed of at least one of BCD 77 and BTD 99.

In other embodiments, in case the printing plan does not require printing an additional image in step 212, the method proceeds to a termination step 214 that concludes the method.

Although the embodiments described herein mainly address distortions related to digital printing of image on a flexible substrate, the methods and systems described herein can also be used in other applications, such as in systems comprising moving flexible substrate/blanket/belt and control means thereof.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
receiving a first signal indicative of a first electrical current measured on a first motion assembly for moving a flexible substrate that receives droplets of a printing fluid from an image forming station to form an image thereon;
receiving a second signal indicative of a second electrical current measured on a second motion assembly for moving the flexible substrate, wherein a section of the flexible substrate is moving between the first and second motion assemblies;
calculating, based on the first and second signals, a parameter, which is indicative of a distortion in the image; and
in response to detecting, based on the parameter, an increase in the distortion, applying a corrective action to reduce the distortion.

2. The method according to claim 1, wherein the image has first and second axes, wherein the distortion comprises a displacement of a pattern, in at least a section of the image, along the first axis that changes with a position along the second axis, and wherein applying the corrective action comprises reducing an increase in the displacement along the first axis.

3. The method according to claim 2, wherein the first axis is orthogonal to the second axis, and wherein the first axis is parallel to a movement axis of the flexible substrate.

4. The method according to claim 2, wherein the first axis is orthogonal to the second axis, and wherein the first axis is orthogonal to a movement axis of the flexible substrate.

5. The method according to claim 2, wherein the image comprises a first color having a first pattern and a second color having a second pattern, wherein the distortion comprises a variation in the displacement between the first pattern and the second pattern, and wherein applying the corrective action comprises reducing an increase in the variation of the displacement.

6. The method according to any of claims 1-5, wherein the distortion comprises a variation in a color-to-color position difference between first and second colors of the image, and wherein applying the corrective action comprises reducing an increase in the variation of the color-to-color position difference in the image.

7. The method according to any of claims 1-5, wherein the distortion comprises a difference between an intended position of the image on the flexible substrate and a measured position of the image on the flexible substrate, and wherein applying the corrective action comprises reducing the difference between the intended position and the measured position.

8. The method according to any of claims 1-5, wherein at least one of the first and second motion assemblies comprises a roller for moving the flexible substrate, and an electrical motor for rotating the roller, and wherein the first electrical current is measured on the electrical motor.

9. The method according to any of claims 1-5, wherein calculating the parameter comprises calculating a difference between the first and second electrical currents, and wherein the calculated difference is indicative of a tension applied to the section of the flexible substrate.

10. The method according to claim 9, wherein applying the corrective action comprises maintaining the tension applied to the section by adjusting a speed in at least one of the first and second motion assemblies.

11. The method according to any of claims 1-5, wherein the flexible substrate comprises an intermediate transfer member (ITM) for transferring the image to a target substrate in an impression station, and comprising receiving a third signal indicative of a velocity of the ITM at the impression station, and wherein applying the corrective action comprises, in response to detecting, based on the third signal, that the velocity has changed beyond a predefined velocity range, adjusting a speed in at least one of the first and second motion assemblies.

12. The method according to claim 11, wherein the impression station comprises an impression cylinder, and wherein the third signal is indicative of a velocity of the impression cylinder.

13. The method according to claim 11, and comprising:
receiving: (i) a first input signal indicative of one or more first variables of the first motion assembly, and (ii) a second input signal indicative of one or more second variables of the second motion assembly, and
defining a virtual axis for determining, based on: (i) the third signal, and (ii) the first and second input signals, a first speed of the ITM in the first motion assembly and a second speed of the ITM in the second motion assembly.

14. The method according to claim 13, wherein the first motion assembly comprises: a first roller, a first motor and a first gear for rotating the first roller, wherein the second motion assembly comprises: a second roller, a second motor and a second gear for rotating the second roller, and wherein applying the corrective action comprises adjusting at least one of the first and second gears in response to detecting that at least one of the first and second variables exceeds a predefined threshold.

15. The method according to claim 13, wherein at least one of the first and second variable is selected from a list consisting of: (i) a diameter of the roller, (ii) a temperature of the roller, and (iii) a nominal speed of the roller.

16. A system, comprising:
an interface, which is configured to: (i) receive a first signal indicative of a first electrical current measured on a first motion assembly for moving a flexible substrate that receives droplets of a printing fluid from an image forming station to form an image thereon, and (ii) receive a second signal indicative of a second electrical current measured on a second motion assembly for moving the flexible substrate, wherein a section of the flexible substrate is moving between the first and second motion assemblies; and
a processor, which is configured to: (i) calculate, based on the first and second signals, a parameter, which is indicative of a distortion in the image, and (ii) in response to detecting, based on the parameter, an increase in the distortion, the processor is configured to apply a corrective action to reduce the distortion.

17. The system according to claim 16, wherein the image has first and second axes, wherein the distortion comprises a displacement of a pattern, in at least a section of the image, along the first axis that changes with a position along the second axis, and wherein the processor is configured to apply the corrective action by reducing an increase in the displacement along the first axis.

18. The system according to claim 17, wherein the first axis is orthogonal to the second axis, and wherein the first axis is parallel to a movement axis of the flexible substrate.

19. The system according to claim 17, wherein the first axis is orthogonal to the second axis, and wherein the first axis is orthogonal to a movement axis of the flexible substrate.

20. The system according to claim 17, wherein the image comprises a first color having a first pattern and a second color having a second pattern, wherein the distortion comprises a variation in the displacement between the first pattern and the second pattern, and wherein the processor is configured to apply the corrective action by reducing an increase in the variation of the displacement.

21. The system according to any of claims 16-20, wherein the distortion comprises a variation in a color-to-color position difference between first and second colors of the image, and wherein the processor is configured to apply the corrective action by reducing an increase in the variation of the color-to-color position difference in the image.

22. The system according to any of claims 16-20, wherein the distortion comprises a difference between an intended position of the image on the flexible substrate and a measured position of the image on the flexible substrate, and wherein the processor is configured to apply the corrective action by reducing the difference between the intended position and the measured position.

23. The system according to any of claims 16-20, wherein at least one of the first and second motion assemblies comprises a roller for moving the flexible substrate, and an electrical motor for rotating the roller, and wherein the first electrical current is measured on the electrical motor.

24. The system according to any of claims 16-20, wherein the processor is configured to calculate the parameter by calculating a difference between the first and second electrical currents, and wherein the calculated difference is indicative of a tension applied to the section of the flexible substrate.

25. The system according to claim 24, wherein the processor is configured to maintain the tension applied to the section by adjusting a speed in at least one of the first and second motion assemblies.

26. The system according to any of claims 16-20, wherein the flexible substrate comprises an intermediate transfer member (ITM) for transferring the image to a target substrate in an impression station, wherein the interface is configured to receive a third signal indicative of a velocity of the ITM at the impression station, and wherein, in response to detecting, based on the third signal, that the velocity has changed beyond a predefined velocity range, the processor is configured to adjust a speed in at least one of the first and second motion assemblies.

27. The system according to claim 26, wherein the impression station comprises an impression cylinder, and wherein the third signal is indicative of a velocity of the impression cylinder.

28. The system according to claim 26, wherein the interface is configured to receive: (i) a first input signal indicative of one or more first variables of the first motion assembly, and (ii) a second input signal indicative of one or more second variables of the second motion assembly, and wherein the processor is configured to define a virtual axis for determining, based on: (i) the third signal, and (ii) the first and second input signals, a first speed of the ITM in the first motion assembly and a second speed of the ITM in the second motion assembly.

29. The system according to claim 28, wherein the first motion assembly comprises: a first roller, a first motor and a first gear for rotating the first roller, wherein the second motion assembly comprises: a second roller, a second motor and a second gear for rotating the second roller, and wherein the processor is configured to apply the corrective action by adjusting at least one of the first and second gears in response to detecting that at least one of the first and second variables exceeds a predefined threshold.

30. The system according to claim 28, wherein at least one of the first and second variable is selected from a list consisting of: (i) a diameter of the roller, (ii) a temperature of the roller, and (iii) a nominal speed of the roller.
